(19) United States
(12) Patent Application Publication
(10) Pub. No.: US 2007/0199342 A1
(43) Pub. Date: Aug. 30, 2007

(54) Method of manufacturing ketchup in red, green or yellow color using liquid kimchi

(75) Inventor: Soo Yeul Lee, Paju-si (KR)

Correspondence Address: KIRTON AND MCCONKIE, 60 EAST SOUTH TEMPLE,, SUITE 1800, SALT LAKE CITY, UT, 84111, US

(73) Assignee: YOUNG HEE KANG, YEOJU-GUN (KR)

(21) Appl. No.: 10/596,978

(22) PCT Filed: Dec. 15, 2004
(86) PCT No.: PCT/KR04/03297

§ 371 Date: Jun. 30, 2006

(30) Foreign Application Priority Data
Jan. 2, 2004 (KR) 2004-0000162
Dec. 13, 2004 (KR) 2004-0105120

(51) Int. Cl. A23G 9/00

(52) U.S. Cl. 62/342

(57) ABSTRACT

The present invention provides a method of manufacturing Kimchi ketchup in red, green or yellow color by processing Kimchi in the form of dressing or sauce to be suited for use of the general public and to be selectively used depending on consumers' taste of its color. The Kimchi ketchup of the present invention has vivid and natural color of green, yellow and red, so that it does not only go beyond the prejudice of general tomato ketchup having limited color and taste, but also does not hint Kimchi to consumers intuitively.

### FIELD OF THE INVENTION

The present invention relates to a method of manufacturing ketchup in color using Kimchi. More particularly, the present invention relates to a method of manufacturing Kimchi ketchup in red, green or yellow color by processing Kimchi, which is a Korean traditional fermented food product having high nutritional value, in the form of a dressing or sauce to be suitable for use of the general public and to be selectively used depending on consumers' taste of its color.

### BACKGROUND OF THE INVENTION

Kimchi is a Korean traditional dish made of vegetables such as cabbages and radishes that are salted, seasoned with green onion, garlic, red pepper powder, ginger, etc., flavored with salted fish such as salted shrimps or anchovies and stored in sealed containers to undergo lactic acid fermentation. It is an essential item in a Korean menu, and recently, its nutritional effects as a fermented food product are well known even in foreign countries.

However, to have the best flavor and taste, Kimchi was necessary to be matured in a container for a predetermined period of time, e.g., 3 to 10 days, and if such period of time had lapsed, it became acidified so easily and its quality and people's liking for Kimchi deteriorated.

Further, regardless of Kimchi's remarkable nutritional value, foreigners and children rarely enjoyed Kimchi because of its peculiar hot taste due to the pepper powder and its stale smelling due to the garlic and the salted shrimps or anchovies. Especially, as most foreigners were not familiar with using chopsticks to have Kimchi, there has been a limitation in Kimchi's popularization.

Further, due to recent westernization of eating habits and increase of consumption of precooked food in Korea, consumption of Kimchi tends to decrease even in the country of origin of Kimchi.

Therefore, methods of promoting consumption of Kimchi and popularizing it have been attempted and researched in various ways, and one example of such an effort has been disclosed in Korean Patent Publication No. 1991-9171 dated Jun. 28, 1991 as “Kimchi ketchup and its manufacturing method”, wherein Kimchi was made by using cabbages as a main ingredient, adding to the cabbages vegetables such as radish, dropwort and leaf mustard, and seasonings such as red pepper powder, garlic, green onion and salted shrimps and anchovies, and mixing them together, and after maturing for a period of time, Kimchi was crushed to make a Kimchi soup, and then a rice gruel and a malt syrup were added to and mixed with the Kimchi soup by stirring, so that Kimchi ketchup was obtained.

In addition, Korean Patent Publication No. 2001-98045 published on Nov. 8, 2001 has disclosed “a manufacturing method of Kimchi juice adsorbing silicone resin”, which comprises salting cabbages for 24 hours; cleaning and crushing the cabbages to make cabbage juice; crushing radishes to make radish juice; adding juice of seasonings such as green onion, garlic and ginger to the radish juice and mixing it with the cabbage juice; pulverizing sesame rice and making a sesame rice gruel to be mixed with the above juice mixture; and adding silicone resin. By using the silicone resin, freshness of Kimchi can be kept and saturation of package of Kimchi products due to the generation of gas can be prevented.

The above-mentioned Kimchi processed products were meaningful in that they attempted to introduce a new usage of Kimchi beyond its conventional usage, which has been merely a side dish during a meal for a long time.

However, since these conventional Kimchi products used all parts of cabbages including green, yellow and white parts thereof by mixing them all together, and used red-colored seasonings, the resulting Kimchi ketchup and juice were muddy and dark in color as a whole.

Further, although Kimchi was processed in the form of ketchup, which is easily and widely used, the Kimchi ketchup still had the flavor of Kimchi, thus making it difficult for many people to approach and enjoy it.

Therefore, the inventor of the present invention studied means and method to overcome the above disadvantages of the conventional technology, and as a result he completed the present invention.

### SUMMARY OF THE INVENTION

An object of the present invention is to provide a method of manufacturing ketchup in yellow or green color as well as red color using Kimchi, which is suitable for use of the general public without having any preconceived idea of Kimchi and selectively available depending on consumers' taste of its color.

Another object of the present invention is to provide a method of manufacturing Kimchi ketchup in color of nature, by separating cabbages into green, yellow and white parts to make Kimchi having respective colors and developing them respectively in the form of ketchup, to stimulate appetite and expand consumer base.

A further object of the present invention is to provide a method of manufacturing Kimchi ketchup in color to promote the consumption of Kimchi.

In order to achieve the above objects, the method of manufacturing ketchup in color using Kimchi according to the present invention comprises:

separating cabbages and side ingredients into green part and white or yellow part;

preparing Kimchi in respective color according to a conventional method, by mixing the white or yellow part of the cabbages with general seasonings for conventional white Kimchi and red Kimchi to make yellow Kimchi and red Kimchi respectively, and by mixing the green part with general seasonings for conventional Kimchi but including green pepper in substitute for red pepper to make green Kimchi;

crushing the respective yellow, red and green Kimchi into 50 to 100 meshes in a high speed crusher;

mixing the respective yellow, red and green Kimchi with a starch gruel in respectively corresponding color of 15-20% by weight of an entire mixture, sugar and/or starch syrup of 8-15% by weight, vinegar or acetic acid of 1-5% by weight, thickening agent and defoaming agent of acceptable intake for man, and a suitable amount of salt by stirring, to have a specific gravity in the range of 1.2-1.3; and

filtering the mixture to obtain filtrate in the form of ketchup.

The above starch gruel in its respective color is manufactured by boiling white cereal flour of rice, wheat, sweet potato and/or potato with water to make white starch gruel, and optionally by adding hulled millet and chopped pumpkin to the white starch gruel for the yellow ketchup, or adding vegetables in red or cereals of black rice and sorghum to the white starch gruel for the red ketchup. The above vegetables and cereals are added for improvement of color vision and nutrition.

The thickening agent is added for the sake of storage, distribution and safety convenience, and it is preferable to use a natural thickening agent such as guar gum (cyamopsis gum) and sodium carboxymethylcellulose.

The defoaming agent may be silicone resin, which prevents saturation of the ketchup product due to generation of foam from Kimchi and keeps the ketchup product fresh.

The Kimchi ketchup manufactured according to the present invention can be used as a dressing or sauce for various foods and can refresh consumers' taste and stimulate their appetite.

### DETAILED DESCRIPTION OF THE PREFERRED EMBODIMENTS

The manufacturing method of the present invention will be described in more detail below, but the scope of the invention is not limited thereto.

<1> Preparation and Separation of Ingredients

General ingredients for Kimchi are cleaned and separated according to their color.

Cabbages are divided into green leaf part as an ingredient for green Kimchi and yellow and white parts as ingredients for yellow and red Kimchi.

Radishes are used for green, yellow and red Kimchi altogether.

As other ingredients, green onion, garlic, ginger, pepper (red and green), leek, cucumber, lettuce, dropwort, leaf mustard, carrot, pear, apple, pumpkin, jujube, etc. are prepared. Of these ingredients, garlic, ginger, pear, and apple are commonly used for green, yellow and red Kimchi. Further, leaf mustard, green pepper, lettuce, leek, cucumber, green parts of green onion and dropwort, etc. may be used for green Kimchi, while pear, pumpkin, etc. may be used for yellow Kimchi, and red pepper, carrot, jujube, white parts of dropwort may be used for red Kimchi.

As salted fish added to Kimchi for flavor and nutrition, salted shrimps, anchovies, sand lance, cuttlefish and shellfish may be commonly used. Especially, salted cuttlefish and anchovies are suitable for red Kimchi.

Further, for the starch gruel, flour of cereal such as rice, wheat, sweet potato and potato can be used. Optionally, hulled millet and chopped pumpkin may be added to the starch gruel for the yellow ketchup, and vegetables in red or cereals of black rice and sorghum are added to the starch gruel for the red ketchup.

<2> Process of the Ingredients

The above separated ingredients are cleaned and dehydrated.

Then, garlic, ginger, red and green peppers, carrots, pumpkins, and jujubes are respectively ground or chopped.

Sugar, starch syrup, vinegar or acetic acid, salt, etc. are separately prepared.

Cabbages are immersed in sodium hypochlorite solution in concentration of 0.1-0.2% for 20 to 30 minutes and cleaned. It is to arrest growth of lactic acid bacteria and to prevent abnormal fermentation of saprophytic bacteria, thus preventing acidification and assuring sanitation.

Then, the cabbages are soaked in saline water in concentration of 8-12% for 6 to 12 hours for a secondary disinfection, and cleaned to remove the remaining sodium hypochlorite and dehydrated.

On the other hand, vegetables and fruits other than the cabbages are parboiled in saline water in concentration of 12% at the temperature of about 70° C., and then dehydrated. Especially, since the green leaf part of the cabbages may discolor into greenish brown during the course of fermentation, parboiling of the green part in the saline water will prevent destruction of chlorophyll and keep vividness of the color green.

Radishes are cut in thin strips.

The salted fish is boiled for 20 to 30 minutes, and then filtered and purified. Then, it is cooled at room temperatures.

The starch gruel is manufactured by boiling sufficiently rice flour, wheat flour, and potato and sweet potato starch powder in water. For yellow ketchup, hulled millet and chopped pumpkin are added to the starch gruel and ground black rice and sorghum are added to the starch gruel for red ketchup.

<3> Preparation of Kimchi

Kimchi is prepared according to a conventional method using the above prepared and processed ingredients.

First, general seasonings and ingredients for conventional white Kimchi are formulated with the white and yellow parts of the cabbages to make yellow Kimchi (generally called “white Kimchi”).

Further white and yellow parts of the cabbages are also formulated with general seasonings and ingredients for conventional red Kimchi.

Further, the green part of the cabbages is formulated with general seasonings and ingredients for conventional red Kimchi, with the exception of green pepper used in substitute for red pepper, to make green Kimchi.

<4> Crushing of Kimchi

The respective yellow, red and green Kimchi obtained as above is matured for the time being, until it has pH 3.5-3.7 and the acidity of 1.0-1.5. The maturity of Kimchi may be determined empirically.

Then, Kimchi is crushed into 50 to 100 meshes in a high-speed crusher.

<5> Production of Kimchi Ketchup

To the respective yellow, red and green Kimchi crushed as above, the starch gruel in respective color, prepared as above, of 15-20% by weight of an entire mixture is added and mixed. Further, sugar and/or starch syrup of 8-15% by weight of an entire mixture, vinegar or acetic acid of 1-5% by weight, thickening agent and defoaming agent of acceptable intake for man, and a suitable amount of salt are added and mixed by stirring, so that the mixture has a specific gravity in the range of 1.2-1.3.

Then, the mixture is filtered in a centrifugal separator.

The filtrate obtained as above is the ketchup of the present invention.

The respective green, yellow and red Kimchi ketchup is kept in containers having predetermined volumes and packed in vacuum.

Alternatively, the Kimchi ketchup in three colors may be filled in one package, so that the ketchup in three colors can simultaneously be discharged from the package.

The Kimchi ketchup of the present invention has the shelf life of about 3 months. It may have the shelf life as long as about 18 months, however, by using Kimchi in green, yellow or red color manufactured according to a conventional method, but omitting the processes of immersing the cabbages in the sodium hypochlorite solution, of parboiling the vegetables and fruits in the saline water at 70° C., and boiling and filtering the salted fish.

As described above, the Kimchi ketchup according to the present invention has vivid and natural color of green, yellow and red, so that it does not only go beyond the prejudice of general tomato ketchup having limited color and taste, but also does not hint Kimchi to consumers intuitively. Therefore, it can be used by wide base of consumers without any negative prejudice.

The Kimchi ketchup of the present invention can be easily and simply dressed or topped for various foods such as vegetable, meat, bakery product, confectionery, rice cake or bread, and steamed rice, and also can be used for decoration of foods in parties to give visual satisfaction and stimulate appetite.

Especially, the green Kimchi ketchup contains a lot of chlorophyll, so that it can be useful as health food or for dietary menu. The yellow Kimchi ketchup has soft texture and smooth color, so that it can be suitably used for children, the old and the weak, and foreigners. Further, the red Kimchi ketchup may be widely used in oriental countries including Korea without prejudice and is also known to be effective in raising immunity of the human body.

Furthermore, the Kimchi ketchup of the present invention is easy to carry, and may be mixed with conventional sauce or dressing or with various flavors to satisfy various tastes of consumers.

Other ingredients such as health foods, nutritional substances or tea may be added to enhance the functionality of the ketchup.

As described above, the ketchup in yellow or green as well as in red using Kimchi, which is manufactured by the present invention, is suitable for use of the general public without having any preconceived idea of Kimchi and selectively available depending on consumers' taste of its color.

According to the present invention, the method of manufacturing Kimchi ketchup in color of nature serves to stimulate consumers' appetite and expand consumer base.

Further, according to the present invention, the method of manufacturing Kimchi ketchup in color may promote the consumption of Kimchi.

It will be apparent to those skilled in the art that various modifications and variations can be made to the present invention without departing from the spirit and scope of the invention. The present invention covers the modifications and variations thereof provided they come within the scope of the appended claims and their equivalents.

1. Method of manufacturing ketchup in color using Kimchi comprising:
separating cabbages and side ingredients into green part and white or yellow part;
preparing Kimchi in respective color according to a conventional method, by mixing the white or yellow part of the cabbages with general seasonings for conventional white Kimchi and red Kimchi to make yellow Kimchi and red Kimchi respectively, and by mixing the green part with general seasonings for conventional Kimchi but including green pepper in substitute for red pepper to make green Kimchi;
crushing the respective yellow, red and green Kimchi into 50 to 100 meshes in a high speed crusher;
mixing the respective yellow, red and green Kimchi with a starch gruel in respectively corresponding color of 15-20% by weight of an entire mixture, sugar and/or starch syrup of 8-15% by weight, vinegar or acetic acid of 1-5% by weight, thickening agent and defoaming agent of acceptable intake for man, and a suitable amount of salt by stirring, to have a specific gravity in the range of 1.2-1.3; and
filtering the mixture to obtain filtrate in the form of ketchup.

2. The method as claimed in claim 1, wherein the starch gruel is manufactured by boiling white cereal flour of rice, wheat, sweet potato and/or potato with water to make white starch gruel, and optionally by adding hulled millet and chopped pumpkin to the white starch gruel for yellow ketchup, or adding vegetables in red or cereals of black rice and sorghum to the white starch gruel for red ketchup.

3. The method as claimed in claim 1, wherein prior to preparing Kimchi in respective color, the white or yellow part of the cabbages is immersed in sodium hypochlorite solution in concentration of 0.1-0.2% for 20 to 30 minutes and cleaned, and the green part of the cabbages is parboiled in saline water in concentration of 12% at temperature of about 70° C. and dehydrated.

4. The method as claimed in claim 1, wherein Kimchi or the starch gruel may further include conventional sauce or dressing, various flavors, health foods, nutritional substances or tea.
